(19) United States
(12) Patent Application Publication
(10) Pub. No.: US 2026/0070489 A1
(43) Pub. Date: Mar. 12, 2026

(54) CONSOLE ARRANGEMENT, IN PARTICULAR CENTER CONSOLE ARRANGEMENT, FOR A MOTOR VEHICLE, AND MOTOR VEHICLE WITH SUCH A CONSOLE ARRANGEMENT

(71) Applicant: AUDI AG, lngolstadt (DE)

(72) Inventors: Jacques HÉLOT, lngolstadt (DE); Christian WALL, Hitzhofen (DE)

(73) Assignee: AUDI AG, lngolstadt (DE)

(21) Appl. No.: 19/305,008

(22) Filed: Aug. 20, 2025

(30) Foreign Application Priority Data
Sep. 12, 2024 (DE) 102024126271.0

(51) Int. Cl. B60R 7/04; B60N 3/10

(52) U.S. Cl. CPC B60R 7/04; B60N 3/102; B60N 3/104

(57) ABSTRACT

A console arrangement, in particular a center console arrangement, for a motor vehicle, includes a console body with a recessed receiving space open at the top and a heating device assigned to it for heating food placed in a container inserted into the receiving space. The heating device is movable between a heating position, in which it is arranged above the container, and a non-use position, in which it is arranged to the side of the container and in which the container is accessible from above.

### FIELD

The invention relates to a console arrangement, in particular a center console arrangement, for a motor vehicle.

### BACKGROUND

It is known to provide a heating device in a motor vehicle with which it is possible to heat food. An example of this can be found in WO 01/37613 A1. There, a motor vehicle is shown with an instrument panel in which a microwave oven is integrated, which is accessible from the vehicle interior so that food can be placed in it and removed again after heating. A comparable device is known from DE 93 17 015 U1. DE 10 2016 012 692 A1 discloses an oven that can be installed as a separate element in a motor vehicle. The oven has several drawer elements that can be pulled out from the oven body and onto which containers containing the appropriate food can be placed. The respective heating devices are usually box-shaped and have a pivoting flap that must be opened to insert the food container and then closed again; the same applies when removing the heated food. This is cumbersome.

### SUMMARY

The object of the invention is to provide an improved console arrangement, in particular a center console arrangement.

To achieve this object, according to the invention, a console arrangement, in particular a center console arrangement, is provided for a motor vehicle, comprising a console body with a recessed receiving space open at the top and a heating device associated therewith for heating a food received in a container introduced into the receiving space, wherein the heating device is movable between a heating position in which it is arranged above the container and a non-use position in which it is arranged to the side of the container and in which the container is accessible from above.

According to the invention, a console arrangement is provided which has a recessed receiving space open at the top, i.e. a correspondingly large compartment which is accessible to the adjacent persons sitting in the vehicle interior. A heating device, preferably in the form of or comprising a radiant heater with a radiation source and a reflector, is assigned to this receiving space for heating a food which is introduced into the receiving space and is accommodated in a container. This heating device is not fixed in position, but can be moved between a heating position in which it is arranged above the container and a non-use position in which the heating device is arranged to the side of the container. When not in use, the container is accessible from above. This makes it possible to move the heating device into the heating position if necessary after positioning the container, i.e. to position it above the container so that the food is heated when the heating device is switched on. After the heating time has elapsed, the heating device can be easily moved from the heating position to a non-use position in which it is away from the container so that the container is accessible from above and the container or its lid can be easily opened so that the food contained in the container can be accessed. For the user, this has the advantage that the heating device is only in the heating position when it is actually needed; otherwise, it can remain in the non-use position, i.e. a stowed position. Furthermore, the container is easily accessible, meaning that the container itself only needs to be touched briefly to open the lid; otherwise, it remains in its position and does not need to be handled. The user therefore does not have to handle the container, even if it is heated, which would be the case, for example, if he had to grasp the container by a handle and pull it out of the otherwise closed heating device.

As described, the heating device can be moved between two positions according to the invention. To achieve this, the heating device can preferably be mounted so that it can be moved via linear guides. The heating device therefore has a corresponding housing which is coupled to the linear guides and over which it is guided. These linear guides can be guide rails or similar.

According to a first alternative of the invention, an actuating means can be provided by means of which the heating device can be moved automatically between the non-use position and the heating position. In this design, the movement of the heating device is therefore carried out automatically via the corresponding actuating means, which causes the movement in both directions. This actuating means can, for example, be a drive motor which meshes via a drive pinion with a rack which is part of the linear guide and is coupled to the housing of the heating device. Alternatively, the actuating means can also be a spindle drive or similar, wherein the invention is not limited to the possibilities mentioned. The actuating means can be controlled and operated via a suitable control element, for example a button on the console body or a control panel on a display menu. This automatic operation can, for example, only be controlled by the user via the control element for moving from the non-use position to the heating position. For example, it is conceivable that after a certain heating time has elapsed, which can also be selected food-specifically if the food type is defined by the user on a display, for example, the heating device is automatically moved back to the non-use position via the actuating means. Of course, it is also conceivable that this backward movement is also controlled by the user himself via the control element.

Alternatively, it is conceivable that the heating device can be moved manually between the non-use position and the heating position. In this variant, the heating device is moved manually by the user.

In this embodiment, it is expedient if the heating device is releasably locked in the non-use position and/or the heating position via a locking device, wherein the locking device preferably has a push-push mechanism. This ensures that the heating device is locked in the respective position and does not move out of position on its own. Preferably, the locking comprises a push-push mechanism, i.e. the user has to briefly press on the heating device or the housing, which leads to the release of the locking mechanism, which automatically engages again when the respective end position is reached and can be released again by pressing again.

In the non-use position, the heating device can be arranged further forward in the console body, i.e. moved forward in the direction of travel, e.g. when the heating device is arranged in a center console of the second row of seats. However, according to a particularly advantageous embodiment of the invention, it is also conceivable that the console body is connected to an instrument panel, wherein the heating device is arranged inside the instrument panel in the non-use position. The heating device can therefore be pushed into the instrument panel and is thus stowed away, so that it is not positioned in the vehicle interior and, in particular, the receiving space is fully accessible when the heating device is in the non-use position.

As described, the heating device is preferably a radiant heater comprising a radiation source, usually an IR radiation source, and a reflector. These elements can be easily integrated into a correspondingly flat housing, so that the heating device itself does not have to be too high.

In order to provide the heating device with a further function in addition to its original heating function, an expedient further development of the invention provides that on the upper side of the heating device, which upper side is exposed in the heating position, a support is provided with an inductive charging device arranged underneath for inductively charging a mobile terminal device placed on the support. As described, the heating device is located in the heating position within or in the region of the upper edge of the receiving space or console body. The upper side of the heating device or housing is therefore freely accessible. According to the invention, there is now a support for at least one mobile terminal, for example a mobile phone, and below the support a corresponding charging device for inductively charging the terminal. The heating device therefore has a dual function, namely an additional charging function in addition to the actual heating function. The design can be such that the heating device, if it can be pushed into the instrument panel and positioned there in the non-use position, can also carry one or more mobile terminals and can continue to charge them in the non-use position, i.e. the heating device only has to be moved out of the instrument panel to place a mobile terminal on it and can then be retracted again.

In a further development of the invention, a holder can be provided in the receiving space, on which the container to be heated can be releasably received, wherein an additional heating element, which is arranged below the container, is preferably provided on the holder. The receiving space is therefore provided with a suitable holder on which the container can be placed or into which it can be inserted. Although in a simple embodiment it is sufficient to heat only from above by means of the heating device, it is advantageous if an additional heating element, for example a resistance heating element, is provided on the holder and is positioned below the container when the container is inserted, via which the container or the food inserted can be heated from below. The heating device, e.g. the radiant heater or the radiation source, and the heating element can be coupled in such a way that they can only be operated together. This coupling can be such that if the heating device is only opened briefly, for example if it is pushed out of the heating position to check the heating process, the lower heating element continues to operate and after being pushed back into the heating position both heat again. The heating element is therefore set to continue running for a short time, and if the heating device is not pushed back into the heating position within the defined time window, the heating element is also switched off.

Furthermore, a receiving frame can be provided in the receiving space adjacent to or below the holder, preferably detachably, which has one or more receptacles arranged one above the other for one or more further containers. This holder can be provided adjacent to the holder, i.e. to the side or offset in the vehicle's longitudinal direction, or below the holder. In any case, one or more additional containers with food can be placed in this receiving frame and removed from it when the food needs to be heated. The receiving frame may have individual compartments that are accessible from the front so that the containers contained therein are easily accessible.

Furthermore, the invention relates to a motor vehicle comprising a console arrangement of the type described above.

### BRIEF DESCRIPTION OF THE FIGURES

Further advantages and details of the present invention will be apparent from the exemplary embodiments described below and in reference to the drawings. In particular:

FIG. 1 shows a perspective schematic representation of a console arrangement of a first embodiment,

FIG. 2 shows a side view, sectioned, of the console arrangement from FIG. 1,

FIG. 3 shows a schematic diagram of the console arrangement of a second embodiment with the heating device in the non-use position,

FIG. 4 shows a schematic diagram of the console arrangement of a second embodiment with the heating device in the heating position,

FIG. 5 shows a perspective view of the console arrangement with the heating device moved out of an instrument panel in the heating position, and

FIG. 6 shows the console arrangement from FIG. 5 with the heating device inserted into the instrument panel.

### DETAILED DESCRIPTION

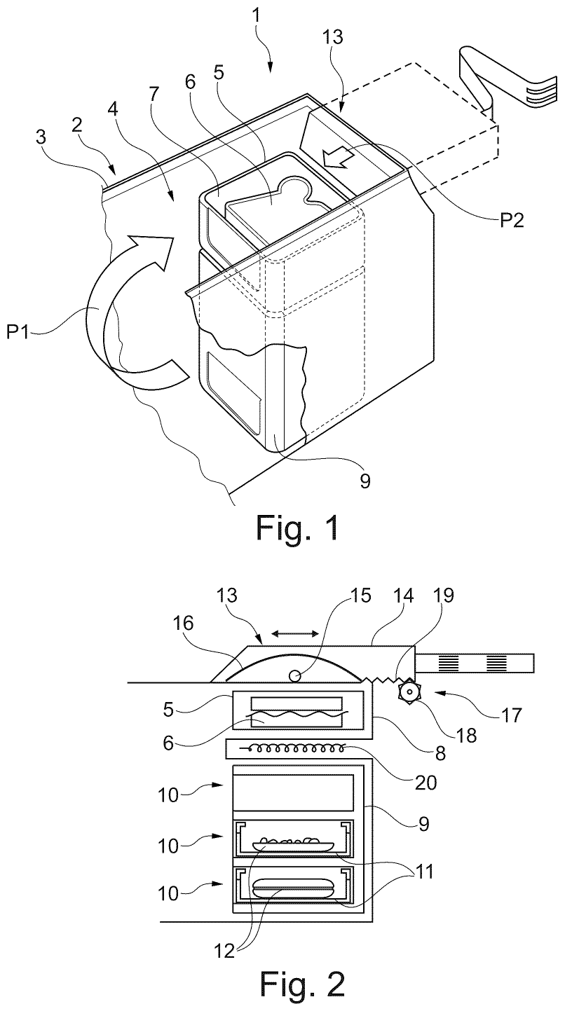

FIG. 1 shows a console arrangement 1 according to the invention in the form of a center console 2, which is intended for a motor vehicle. The console arrangement 1 comprises a console body 3 with a recessed receiving space 4 that is open at the top. In the receiving space 4 there is a container 5 with a food 6 that is to be heated contained therein. The container 5 is made of glass or a transparent plastic, for example, and has a lid 7 which is mounted in a pivotable or foldable manner so that the container 5 can be easily opened and the heated food 6 can be removed.

Below the container 5, which is arranged on a holder 8 shown in the side view according to FIG. 2, there is a receiving frame 9 in which several compartments or receptacles 10 are provided, in each of which further containers 11 with food 12 are received, as shown in FIG. 2. Such a container 11 can be inserted into the holder 8, as shown by the arrow P1 in FIG. 1, if the food 6 has previously been heated and removed and the container 5 has been removed from the holder 8.

Furthermore, a heating device 13 is provided, comprising a housing 14 in which a radiation source 15, preferably an IR radiator, and a reflector 16 are accommodated. It is therefore a radiant heating device. This heating device 16 serves to heat the food 6 in the container 5.

In FIG. 1, the heating device 13 is in a non-use position in which it is pushed into the interior of an instrument panel, i.e. stowed away, as will be discussed below. As shown by the arrow P2, the heating device can be moved from this non-use position into a heating position shown in FIG. 2, in which it is arranged above the container 5 with the food 6 to be heated. The movement from the non-use position according to FIG. 1 into the heating position according to FIG. 2 can be carried out manually, wherein the heating device 13 is preferably locked in the respective position via a locking device, for example a push-push mechanism, and is moved accordingly manually after releasing the locking mechanism. Alternatively, it is conceivable, as shown in FIG. 2, to provide an actuating means 17, for example a drive motor with a gear 18 which meshes with a rack 19 which is coupled to the housing 14. In this embodiment, the movement of the heating device 13 between the two positions takes place automatically via the actuating means 14, which can be controlled, for example, via a control element provided on the console body 3 or on a display not shown in detail. As an alternative to the gear connection, a threaded spindle drive or similar would also be conceivable. In any case, regardless of whether the movement is manual or automatic, the heating device 13 or the housing 14 is guided longitudinally on corresponding linear guides arranged on the console body 3.

In the position shown in FIG. 2, the heating device 13 is located exactly above the container 5, so that when the radiation source 15 is in operation, the heating radiation is reflected via the reflector 16 onto the food to be heated, which is then heated. As FIG. 2 further shows, a further heating element 20 can be provided which is arranged in a fixed position on the holder 8 or below it and which can be, for example, a resistance heater. The food 6 can also be heated from below using this additional heating element 20.

After the heating has ended, the heating device 13 is moved again from the heating position shown in FIG. 2 into the non-use position shown in FIG. 1, which can be done as described either manually by releasing the push-push mechanism again and pushing the heating device 13 back until the push-push mechanism engages again, or by the actuating means 17 automatically moving the heating device 13 back into the non-use position. The container 6 is then free again as shown in FIG. 1, i.e. is accessible from above, so that the lid 7 can be easily opened and the food removed, and if necessary the container 5 can be removed from the holder 8 and exchanged for another container 11, whereupon a new heating process starts.

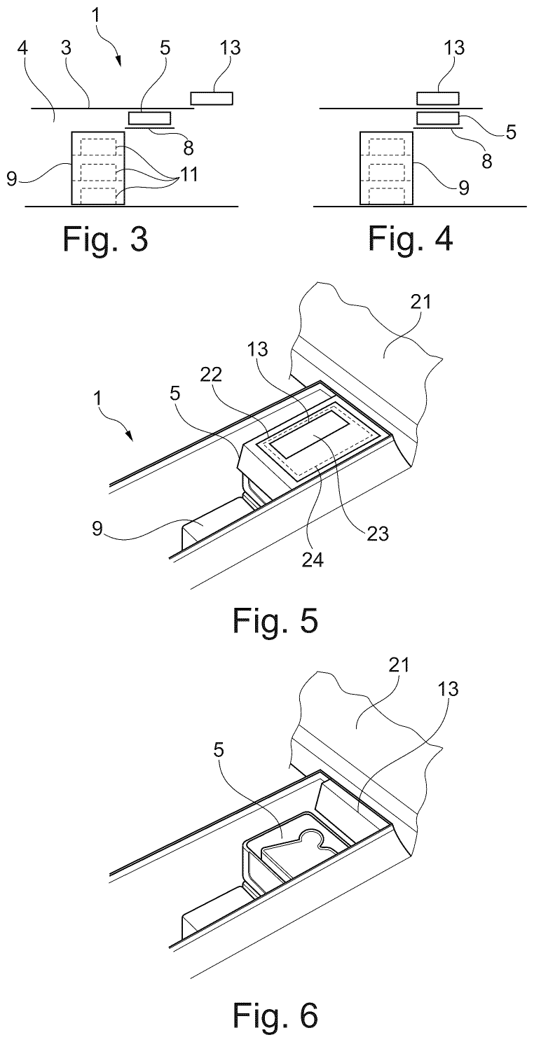

FIGS. 3 and 4 again show a simplified representation of a second embodiment of a console arrangement 1, wherein the same reference numerals are used for the same components. Here, too, a console body 3 is provided with a receiving compartment 4, in which a receiving frame 9 with multiple inserted containers 11 is shown. Furthermore, the holder 8 is shown with a container 5 arranged thereon, which contains a food to be heated. Also shown is the heating device 13, which is in the non-use position in which it is positioned to the side of the container 5 accessible from the top. In contrast to the previous embodiment, in which the receiving frame is located directly below the holder 8, here the receiving frame 9 is positioned offset in front of the holder 8, virtually opposite to the direction of travel of the motor vehicle.

Finally, FIG. 4 shows the heating device 13 in the heating position in which it is arranged above the container 5.

FIGS. 5 and 6 further show a console arrangement 1, wherein again the same reference numerals are used for the same components. The design is similar to that according to FIGS. 3 and 4, i.e. here too the receiving frame 9 is arranged in front of the holder and the container 5 arranged thereon with the food to be heated. In FIG. 5, the heating device 13 is shown in the heating position above the container 5. For this purpose, the heating device 13 is moved out of a receptacle in an instrument panel 21, either manually or automatically as already described above. In the non-use position shown in FIG. 6, the heating device 13 is inserted into the receptacle of the instrument panel 21 and is almost completely or even completely accommodated therein. It is evident that the container 5 is exposed at the top, so that access is possible from above to remove the mentioned food. The movement of the heating device 13 between the two positions shown in FIGS. 5 and 6 can again be carried out manually or automatically via an actuating means.

As FIG. 5 further shows, a support 22 for a mobile terminal 23 can be provided on the top side of the housing 14, which can be charged via an inductive charging device 24 integrated in the housing 14. This configuration is conceivable for all described embodiments.

1. A console arrangement, in particular a center console arrangement, for a motor vehicle, comprising: a console body with a recessed receiving space open at the top and a heating device assigned to it for heating food placed in a container inserted into the receiving space, wherein the heating device is movable between a heating position, in which it is arranged above the container, and a non-use position, in which it is arranged to the side of the container and in which the container is accessible from above.

2. The console arrangement according to claim 1, wherein the heating device is mounted displaceably via linear guides.

3. The console arrangement according to claim 1, further comprising: an actuating means by which the heating device can be moved automatically between the non-use position and the heating position.

4. The console arrangement according to claim 1, wherein the heating device can be moved manually between the non-use position and the heating position.

5. The console arrangement according to claim 4, wherein the heating device is releasably locked in the non-use position and/or the heating position via a locking device, wherein the locking device preferably has a push-push mechanism.

6. The console arrangement according to claim 1, wherein the console body adjoins an instrument panel, wherein the heating device is arranged in the interior of the instrument panel in the non-use position.

7. The console arrangement according to claim 1, wherein the heating device has a housing in which a radiation source and a reflector are accommodated.

8. The console arrangement according to claim 1, wherein on the upper side of the heating device, which is exposed in the heating position, a support with an inductive charging device arranged underneath is provided for inductively charging a mobile terminal placed on the support.

9. The console arrangement according to claim 1, further comprising: a holder provided in the receiving space, on which the container to be heated can be releasably received, wherein an additional heating element is preferably provided on the holder, which is arranged below the container.

10. The console arrangement according to claim 9, wherein a receiving frame is provided in the receiving space adjacent to or below the holder, preferably detachably, which has one or more receptacles arranged one above the other for one or more further containers.

11. A motor vehicle, comprising: a console arrangement according to claim 1.

12. The console arrangement according to claim 2, further comprising: an actuating means by which the heating device can be moved automatically between the non-use position and the heating position.

13. The console arrangement according to claim 2, wherein the heating device can be moved manually between the non-use position and the heating position.

14. The console arrangement according to claim 2, wherein the console body adjoins an instrument panel, wherein the heating device is arranged in the interior of the instrument panel in the non-use position.

15. The console arrangement according to claim 3, wherein the console body adjoins an instrument panel, wherein the heating device is arranged in the interior of the instrument panel in the non-use position.

16. The console arrangement according to claim 4, wherein the console body adjoins an instrument panel, wherein the heating device is arranged in the interior of the instrument panel in the non-use position.

17. The console arrangement according to claim 5, wherein the console body adjoins an instrument panel, wherein the heating device is arranged in the interior of the instrument panel in the non-use position.

18. The console arrangement according to claim 2, wherein the heating device has a housing in which a radiation source and a reflector are accommodated.

19. The console arrangement according to claim 3, wherein the heating device has a housing in which a radiation source and a reflector are accommodated.

20. The console arrangement according to claim 4, wherein the heating device has a housing in which a radiation source and a reflector are accommodated.
